(19) United States
(12) Patent Application Publication
(10) Pub. No.: US 2011/0283554 A1
(43) Pub. Date: Nov. 24, 2011

(54) Device for Drying Bulk Material in at least one Storage Container

(75) Inventors: Holger Kühnau, Konstanz (DE); Reinhard Herro, Kempten (DE)

(73) Assignee: MOTAN HOLDING GMBH, Konstanz (DE)

(21) Appl. No.: 13/107,878

(22) Filed: May 14, 2011

(30) Foreign Application Priority Data
May 20, 2010 (DE) 10 2010 021 742.5

(51) Int. Cl. F26B 21/08; F25B 21/02

(52) U.S. Cl. 34/79

(57) ABSTRACT

Before being processed, bulk material is dried in a storage container. A drying medium such as air is passed through the bulk material for drying. The drying medium heats the bulk material and removes moisture at the same time. For dehumidifying the drying medium, a dehumidifying unit with a Peltier device is provided whose cold side and whose hot side are positioned within the flow path of the drying medium. The drying medium loaded with moisture is passed across the cold side and dehumidified. The hot side of the Peltier device is used to preheat the dehumidified drying medium.

### BACKGROUND OF THE INVENTION

The invention concerns a device for drying bulk material contained in at least one storage container. At least one supply conduit for a gaseous drying medium, preferably air, opens into the container and at least one outlet conduit is connected to the container into which the drying medium in the form of return air, loaded with moisture after having passed the bulk material, flows. At least one dehumidifying unit is provided with which the drying medium is dehumidified,

Before being processed, bulk material is dried in the storage container for which purpose a drying medium, preferably air, is passed through the bulk material. The drying medium heats up the bulk material and removes at the same time moisture. The drying medium that is loaded with the moisture leaves the storage container through the outlet conduit. This so-called return air is subsequently passed through a drying agent in order to dehumidify the drying medium again and return it to the bulk material. In order to remove moisture from the drying medium, refrigeration devices of conventional construction are used with which the drying medium is cooled for removal of the moisture. Partially, the hot exhaust air of the refrigeration device is also utilized in order to reheat the drying medium after the dehumidifying process in order to return it to the bulk material. Such refrigeration devices are not only expensive facility parts but require also significant space.

It is an object of the invention to design the device of the aforementioned kind such that in a constructively simple way at low cost and construction expenditure the drying medium can be dehumidified after having passed through the bulk material.

### SUMMARY OF THE INVENTION

This object is solved for the device of the aforementioned kind in accordance with the present invention in that the dehumidifying unit is provided with at least one Peltier device whose cold side and whose hot side are positioned within the flow path of the drying medium.

In the device according to the invention, the dehumidifying unit is provided with at least one Peltier device whose cold side and whose hot side are positioned in the flow path of the drying medium. By applying an electrical voltage to the Peltier device, the cold side and the hot side of the Peltier device are generated. On the cold side, temperatures far below the freezing point of water, for example, −40 degrees Celsius, can be generated. When the drying medium loaded with the moisture is passed across the cold side of the Peltier device, the dehumidifying process is realized. In this connection, two stages of drying medium can be generated. When at the cold side of the Peltier device purely a condensation of the moisture contained in the drying medium occurs, then dew points above the freezing point of the water are achieved. However, it is also possible to remove moisture from the drying medium at the cold side of the Peltier device by freezing. In this connection, dew points are achieved that are far below the freezing point of water.

On the hot side of the Peltier device, the dehumidified drying medium can be heated again so that preheating of the dehumidified drying medium can be achieved. In this way, a significant amount of energy for the drying process is saved.

The Peltier devices themselves are small plate-shaped Peltier devices with minimal dimensions. The typical dimensions of Peltier devices are between approximately 55 to 100 mm in width, approximately 55 to 100 mm in height, and approximately 4 mm in depth. The Peltier devices thus require little space so that the dehumidifying unit can be designed to be compact. The dehumidifying unit is problem-free in operation but enables still a reliable drying action of the drying medium.

The cold side and the hot side of the Peltier device each are advantageously part of a heat exchanger. When the drying medium passes through these heat exchangers, the heat and the cold can be reliably transferred onto the drying medium. Advantageously, in this connection cooling bodies of aluminum or any other suitable materials are used with which the heat or cold can be transferred optimally to the drying medium.

Advantageously, the supply conduit is fluidically connected with the dehumidifying unit through which the drying medium that has been dehumidified in the dehumidifying unit is supplied to the storage container immediately after the dehumidifying process.

Advantageously, the dehumidifying unit is also in flow communication with the outlet conduit of the storage container. The drying medium that is loaded with moisture is supplied, after having passed through the bulk material in the storage container, directly to the dehumidifying unit and is dehumidified thereat.

It is possible to connect to the dehumidifying unit at least one intake conduit for ambient air. The sucked-in ambient air that is generally loaded with moisture is dehumidified within in the dehumidifying unit before it can be supplied as a drying medium to the storage container. Such a configuration is particularly advantageously suited for use in Asian regions in which the ambient air has high humidity. By means of the dehumidifying unit the ambient air can be dehumidified effectively to such an extent that it can be used as a drying medium for drying the bulk material in the storage container.

An especially favorable configuration results when the dehumidifying unit is disposed within a circuit of a drying medium. In this case, the drying medium can be passed in circulation through the device according to the invention. After having passed through the bulk material, the drying medium loaded with moisture is supplied to the dehumidifying unit and is dehumidified therein. Subsequently, the drying medium that has been dehumidified in this way is returned to the bulk material in order to remove moisture from the bulk material.

In order to achieve a high efficiency, it is advantageous when the device has at least two dehumidifying units. In this connection, it is advantageous when the two dehumidifying units are combined such that one dehumidifying unit can be subjected to a deicing process while the other dehumidifying unit, parallel to this deicing process, can be utilized still for dehumidifying the drying medium. Overtime, on the cold side of the Peltier device ice is formed that must be removed in order to be able to perform an optimal dehumidification. As a result of the described advantageous configuration, this deicing process can be performed without having to interrupt the dehumidification process.

Advantageously, the flow path of the drying medium can be switched/controlled by means of valves.

In order to increase the temperature difference, it is advantageous to employ several Peltier devices that can be arranged in a row one after another as well as in a row one after another and in a row adjacent each other within the dehumidifying unit.

Further features of the invention result from the further claims, the description and the drawings.

### BRIEF DESCRIPTION OF THE DRAWINGS

The invention will be explained in the following with the aid of several embodiments illustrated in the drawings in more detail.

FIG. 1 a) shows a dehumidifying unit of the device according to the invention for drying bulk material.

FIG. 1 b) shows a variant of the arrangement of the Peltier devices of the dehumidifying unit.

FIG. 1 c) shows another variant of the arrangement of the Peltier devices of the dehumidifying unit.

FIG. 2 shows a further embodiment of the dehumidifying unit.

FIG. 3 illustrates another embodiment of the dehumidifying unit.

FIG. 4 shows another embodiment of a device according to the invention.

FIG. 5 shows yet another embodiment of a device according to the invention.

FIG. 6 shows a further embodiment of a device according to the invention.

FIG. 7 shows another embodiment of a device according to the invention.

FIG. 8 show another embodiment of a device according to the invention.

FIG. 9 shows a further embodiment of a dehumidifying unit in a first operating position.

FIG. 10 shows the embodiment of FIG. 9 in a second operating position.

FIG. 11 shows a further embodiment of a device according to the invention in a first switched position of the correlated dehumidifying units.

FIG. 12 shows the embodiment of FIG. 11 in a second switched position of the correlated dehumidifying units.

FIG. 13 shows another embodiment of a device according to the invention with the correlated dehumidifying units in a first switching position.

FIG. 14 shows another embodiment of a device according to the invention with the correlated dehumidifying units in a second switching position.

FIG. 15 shows a further embodiment of a device according to the invention in an illustration according to FIG. 13.

FIG. 16 shows the embodiment of FIG. 15 in an illustration according to FIG. 14.

### DESCRIPTION OF PREFERRED EMBODIMENTS

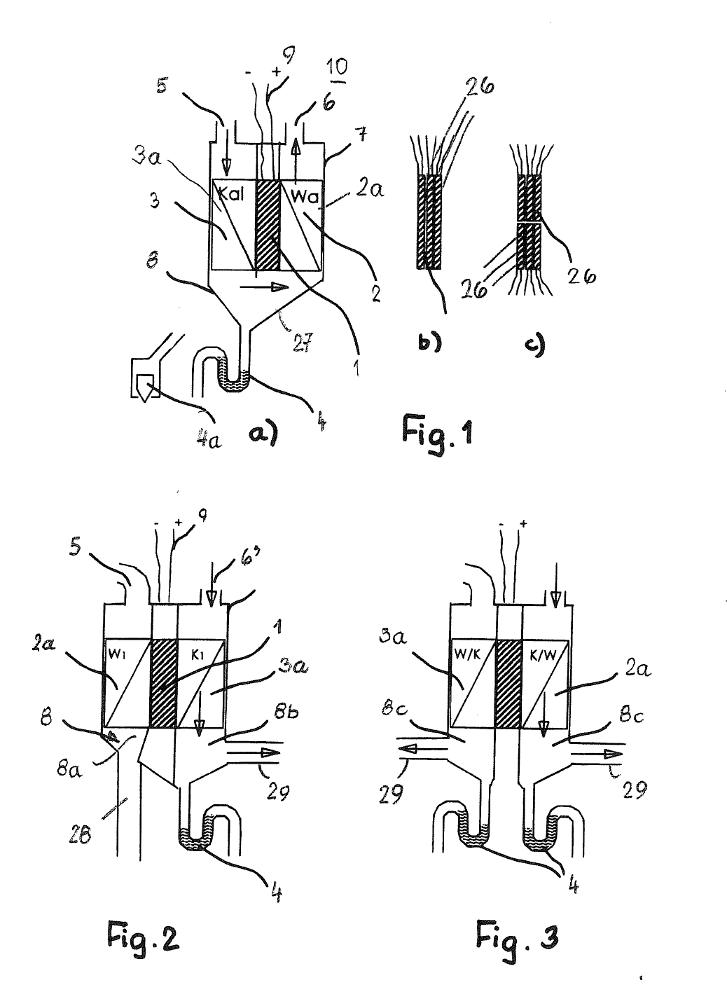

With the aid of FIGS. 1 to 3 the principle of the device according to the invention for drying bulk material will be explained. For drying the bulk material, dehumidifying units 10 are used that have at least one Peltier device. The dehumidifying unit 10 has a housing 7 that is divided by a partition 1 into two flow chambers 2, 3. The partition 1 is provided with at least one Peltier device 26. As illustrated in FIGS. 1b and 1c, several Peltier devices 26 can be arranged in series one after another (FIG. 1b) but also in series one after another and in series neighboring each other (FIG. 1c). When using several Peltier devices 26 an increase of the temperature difference is possible.

Peltier devices have the property that, when applying a current, one flat side is heated and the other is cooled down.

In the embodiment according to FIG. 1a the cold side of the Peltier device 26 is in the flow chamber 3 and the hot side in the flow chamber 2. As a result of the different temperatures at both sides of the Peltier device 26, there is the possibility to use the Peltier devices as a part of heat exchangers 2a, 3a. By means of the heat exchangers 2a, 3a, the heat or the cold can be transferred onto the respective gas to be dried. The cooling bodies of the heat exchangers 2a, 3a are comprised advantageously of aluminum. However, they can also be comprised of other suitable materials that transfer heat or cold well to the gas to be dried.

An inlet opening 5 through which the gas to be dried enters in the direction of the arrow opens into the flow chamber 3. It flows from the top to the bottom through the heat exchanger 3a. The flow direction can also be from the bottom to the top or transverse if this is expedient for the drying process. The moisture contained in the gas precipitates on the cold surface of the heat exchanger 3a by condensation. At the same time, the gas is cooled thereby. After having passed through the heat exchanger 3a, the gas enters the flow chamber 8 in which the dehumidified gas flows in the direction toward the heat exchanger 2a. In it, the gas flows upwardly and reaches after having passed through the heat exchanger an outlet 6 through which the gas exits from the housing 7. The heat exchanger 2a has correlated therewith the hot side of the Peltier device 26 so that the gas when passing through the heat exchanger 2a is heated by the hot side of the Peltier device 26. The heated gas that flows out of the outlet 6 will be supplied in a way to be described in the following to the bulk material container in which the bulk material to be dried is positioned. Since for drying the bulk material the heated gas is used, the entire energy, including the losses as a result of the degree of efficiency of the Peltier device 26, can be utilized. The energy serves for dehumidifying the gas by means of the heat exchanger 3a as well as for heating the gas with the aid of the heat exchanger 2a.

The moisture that deposits on heat exchanger 3a forms droplets by accumulation that exit from heat exchanger 3a in downward direction and drip into the lower flow chamber 8. Since the flow chamber 8 tapers conically in downward direction, the condensed droplets run along the slanted wall 27 downwardly into an outlet pipe 4. In the illustrated embodiment, it is embodied as a siphon pipe so that it is ensured that the flow/collection chamber 8 remains air-tight when draining the condensate collected in the chamber 8.

Instead of the siphon pipe 4 also any other suitable device can be employed, for example, a float valve 4a with which also the collected condensates can be drained.

By means of the at least one Peltier device 26 the gas is dried by condensation and/or freezing of the moisture entrained in the gas and in this way dry gas, preferably dry air, is generated with which in the way to be described subsequently the bulk material is dehumidified and heated.

By applying an electrical voltage to the Peltier device 26, on the cold side temperatures far below the freezing point of water, for example, −40 degrees Celsius, can be generated. Two stages of dry air are generated in this connection. For purely a condensation action of the moisture contained in the gas, dew points above the freezing point are reached. When the moisture is removed by freezing from the gas, dew points far below the freezing point of water are achieved.

The Peltier devices 26 fulfill in the described way a double function: The gas is first dehumidified by cooling and is then subsequently heated after the dehumidifying process by the hot side of the Peltier devices 26. In this way, in particular energy for drying the bulk material is saved. Moreover, as a result of the use of the Peltier devices 26 very small drying devices can be constructed.

Peltier devices have typical dimensions of 55 to 100 mm in width, 55 to 100 mm in height, and 4 mm in depth. In accordance with the applied voltage and the performance of the employed the Peltier device 26, a smaller or greater temperature difference between the two flat sides of the Peltier device is produced. In order to increase this temperature difference, several Peltier devices can be connected in series.

When the gas is to be dried to a very minimal residual moisture contents, the Peltier devices 26 are designed such that very low temperatures of, for example, −40 degrees Celsius are reached. The moisture contained in the gas is then not only condensed on the walls of heat exchanger 3a; the moisture forms also frost on the walls. With increasing duration of use, the cold side of the Peltier devices 26 becomes clogged by ice formation. Therefore, this cold side of the Peltier devices must be deiced from time to time. It is advantageous in this case to reverse polarity of the supply conduits 9 of the Peltier devices. Then the prior cold side now becomes the hot side of the Peltier devices so that the ice that has formed thereon will melt. The heat that is released by the Peltier device 26 can, in turn, be used for heating the gas before drying the bulk material.

The cold side of the Peltier devices 26 can also be deiced passively. For this purpose, the hot moist exhaust air from the bulk material container is first passed across the icy cold side of the Peltier devices 26 so that the ice formed on the cold side is thawed. Moreover, the gas is in this way precooled and also moisture by condensation is removed from the gas. The condensation heat that is released in this way contributes to quick thawing of the ice on the cold side of the Peltier device. Subsequently, the gas is advantageously brought to the required degree of dryness in a further chamber by freezing the residual moisture in the gas.

It is important for the operation that the ice upon thawing will not sublimate but instead will become liquid and therefore can be removed from the drying process as a condensate. This condensate that is formed by condensation as well as by freezing and subsequent liquefaction flows downwardly into the collecting chamber 8 from where the condensate in the described way can be drained through the siphon pipe 4 or in an exemplary fashion by means of the float valve 4a.

FIG. 2 shows the possibility to divide the collecting/flow chamber 8 into two chambers 8a, 8b. The chamber 8a serves for discharging the heated air that has passed through the heat exchanger 2a. Via the conduit 28 the dried and heated air is then supplied to the downstream bulk material container.

In the chamber 8b the condensate that has formed upon passing through the heat exchanger 3a is discharged through the outlet pipe 4 in the described way from the process. The gas flows after exiting from heat exchanger 3a into a pipe 29 that is connected transversely.

In the embodiment according to FIG. 3 the Peltier devices 26 can be reversed in polarity independent of each other so that the heat exchangers 2a, 3a, depending on polarity, can be used for heating or cooling of the gas. In order to remove the ice formed at the cold side of the Peltier devices, the Peltier devices are reversed in polarity such that the ice is thawed and the condensate that will form will flow downwardly into the collecting chambers 8c that are separated from each other. The condensate flows downwardly into the outlet pipes 4 that in an exemplary fashion are embodied as siphon pipes, respectively. The gas itself flows in the laterally connected pipes 29 out of the respective collecting chamber 8c. The pipes 29 in the flow direction of the gas are located downstream of the heat exchangers 2a, 3a.

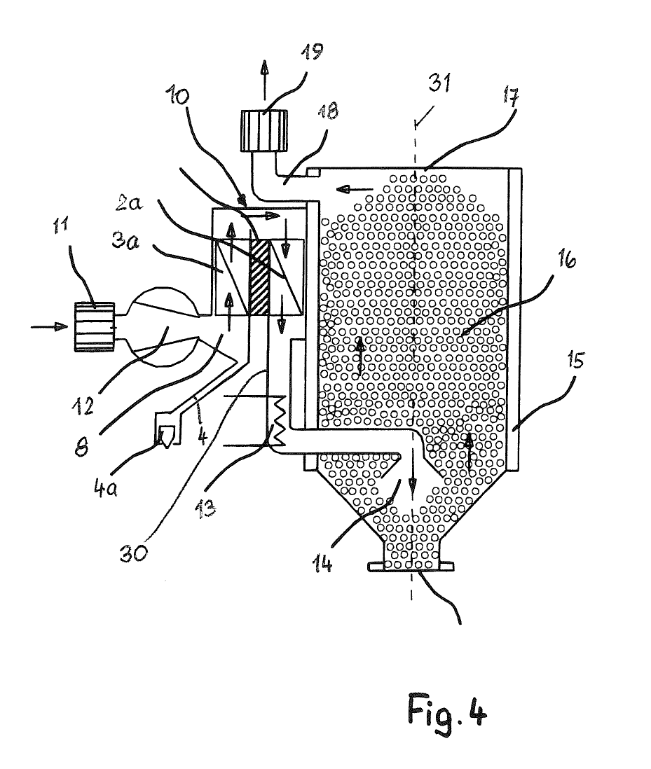

FIG. 4 shows a device for drying the bulk material 16 in a storage container 15. The container 15 is provided at the upper end with at least one outlet 18 for the drying medium. It flows through an air filter 19 into the environment.

As drying medium ambient air is used that is sucked in by means of a blower 12. The ambient air flows first through an air filter 11 before it is supplied to the dehumidifying unit 10 by the blower 12. The sucked-in ambient air flows from the bottom into the heat exchanger 3a of the dehumidifying unit 10. The moisture contained in the ambient air condenses and drips downwardly into the collecting chamber 8. From here, the condensate reaches the outlet pipe 4 from where the condensate can be drained by means of the float valve 4a.

The air after passing through the heat exchanger 3a is deflected at a right angle and passes into the heat exchanger 2a through which the ambient air flows from top to bottom. In the heat exchanger 2a the dehumidified ambient air is heated. After this preheating step, in which the exhaust heat of the dehumidifying process is utilized, the dehumidified ambient air flows into a supply conduit 30 in which a heating device 13 is located. The air is heated by it to the required drying temperature before entering the storage container 15. Near the lower end the supply conduit 30 extends perpendicularly to the container axis 31 into the storage container 15. The free end of the supply conduit 30 is arranged centrally in the storage container 15 and is oriented downwardly. The outlet end 14 of the supply conduit 30 is conically designed and widens in the flow direction of the ambient air in downward direction. The heated dehumidified ambient air enters thus near the lower end in downward direction the storage container 15. In the bulk material 16 the ambient air flows in the direction of the illustrated flow arrows upwardly and absorbs as a result of the vapor diffusion difference between the dry ambient air and the moist bulk material 16 the moisture contained in the bulk material. When doing so, the ambient air is cooled and flows at the upper end of the storage container 15 through the outlet 18 and the air filter 19 out to the exterior.

The storage container 15 is closed at the upper end by a cover 17 that also serves for deflecting the air flowing upwardly through the bulk material 16 in the direction toward the outlet 18.

Since the ambient air after having passed through the bulk material 16 is released into the environment, an open process control is used with this device that utilizes ambient air for drying the bulk material 16. Such an open process control is well-suited for drying with gas having dew points above approximately 0 degrees Celsius.

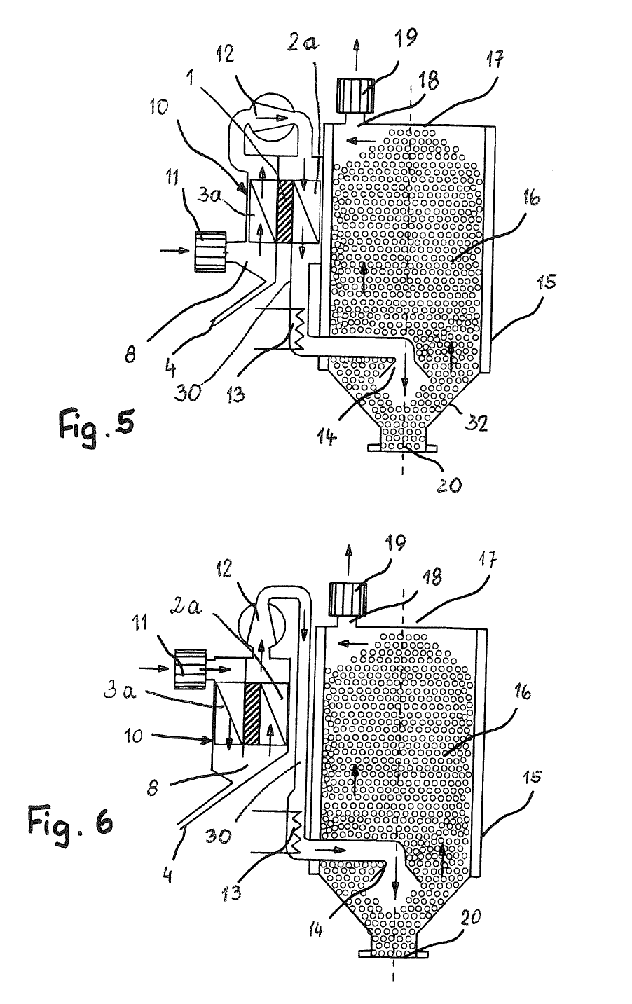

In the embodiment according to FIG. 5 the blower 12 with which the ambient air is sucked in is located in the flow direction downstream of the dehumidifying unit 10. The sucked-in air passes first through the air filter 11 and then flows into the chamber 8 of the dehumidifying unit 10. From here, the ambient air flows through the heat exchanger 3a from the bottom to the top. In the flow direction behind this heat exchanger 3a the blower 12 is arranged that supplies the ambient air that has been dehumidified by heat exchanger 3a to the heat exchanger 2a of the dehumidifying unit 10. It is flowed through from the top to the bottom and heated by means of the Peltier devices at the partition 1. The ambient air that is dehumidified and pre-heated in this way flows according to the preceding embodiment into the supply conduit 30 that is connected to the dehumidifying unit 10. The heating device 13 contained therein heats the pre-heated dehumidified ambient air to the temperature required for drying the bulk material 16 in the storage container 15. The supply conduit 30 is embodied in the same way as in the embodiment according to FIG. 4 so that the heated ambient air passes through the funnel-shaped outlet end 14 near the lower end of the storage container 15 into the bulk material 16. The air flows in the bulk material 16 upwardly, heats thus the bulk material 16 and in this way absorbs the moisture from the bulk material. The temperature of the heated ambient air is only so high that damage of the bulk material 16 by drying temperatures that are too high is reliably prevented.

In contrast to the embodiment of FIG. 4 in which the outlet 18 is near the cover 17 at the sidewall of the storage container 15, the outlet 18 in the present embodiment is within the cover 17. The ambient air flows through the outlet 18 and the air filter 19 into the environment.

The condensate that forms within the heat exchanger 3a flows downwardly into the collecting chamber 8 and from there into the outlet pipe 4.

The storage container 15 has a lower conically tapering end 32 that is closed off by closure 20 that may be, for example, a slide or a flap.

In the embodiment according to FIG. 6, the blower 12 is also arranged in flow direction downstream of the dehumidifying unit 10. The ambient air flows through the air filter 1 into the dehumidifying unit 10. The air flows first through heat exchanger 3a downwardly, reaches the flow chamber 8 and from there flows into heat exchanger 2a. In the heat exchanger 3a the air is dehumidified. The generated condensate drips downwardly into the collecting chamber 8 and can be drained via the outlet pipe 4. In the heat exchanger 2a the dehumidified ambient air is pre-heated and flows into the supply conduit 30. With the heating device 13 that is located in the supply conduit 30 the downwardly flowing ambient air is heated and enters through the outlet end 14 the bulk material 16 in the storage container 15. The heated ambient air flows within the bulk material 16 to the top and exits through the outlet 18 as well as the connected air filter 19 to the exterior. The outlet 18, as in the preceding embodiment, is provided in the cover 17 near the sidewall of the container 15. In the embodiment according to FIG. 6, the blower 12 is provided in the flow direction behind the heat exchanger 2a. In the preceding embodiment the compressor 12 is arranged in the flow direction behind the heat exchanger 3a as well upstream of the heat exchanger 2a.

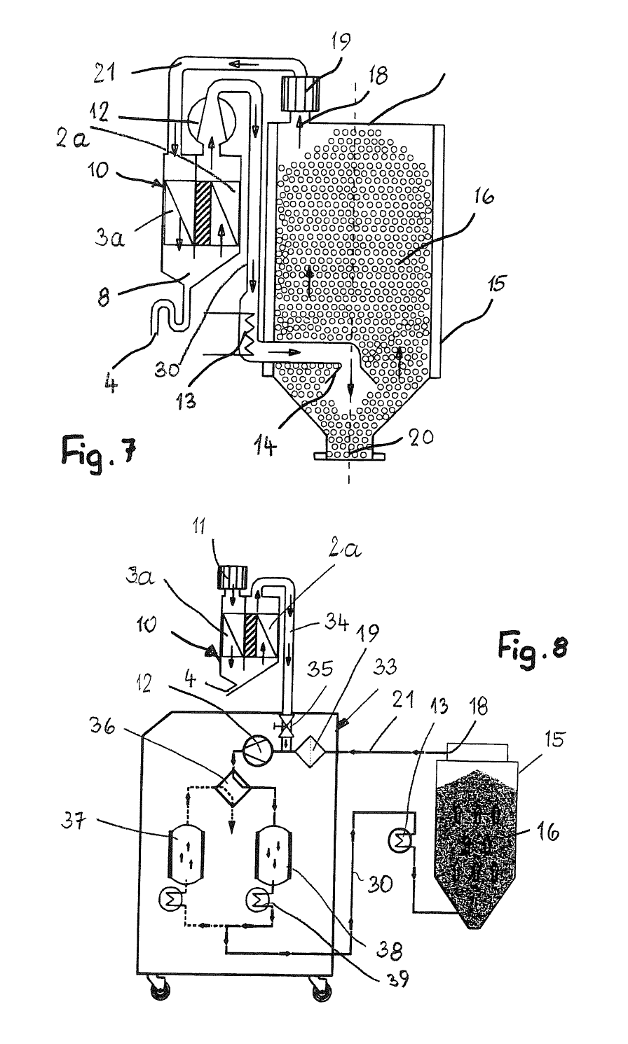

In the embodiment according to FIG. 7 the air after having passed through the air filter 19 is not released at the outlet 18 into the environment but is supplied to the dehumidifying unit 10. These devices operate with a closed circuit and are filled with the bulk material 16 often by hand through a flap cover 17. Only when opening the flap cover 17 air exchange between the flow chamber and the environment takes place. Such embodiments are especially suitable when the bulk material 16 in the storage container 15 contains only little moisture. In this way, the air when passing through the bulk material 16 therefore absorbs accordingly only little moisture so that the return air is significantly drier than the alternatively employed ambient air that, for example, in Asian regions contains a significant amount of moisture. The energy consumption of the drying device as a result of the minimal moisture of the return air is thus very beneficial.

The return air flows from the air filter 19 through a connecting conduit 21 into the dehumidifying unit 10. The return air flows first through the heat exchanger 3a in which the dehumidification takes place. The condensate that is formed can pass through the collecting chamber 8 into the outlet pipe 4 that is embodied as a siphon pipe. The air flows in the heat exchanger 3a downwardly and passes into the flow chamber 8. Here the air is deflected toward the heat exchanger 2a through which the air flows from the bottom to the top. As this happens, the air is preheated by the hot side of the Peltier devices 26. In the flow direction downstream of the heat exchanger 2a in accordance with the embodiment of FIG. 6 the blower 12 is arranged with which the pre-heated air flows into the supply conduit 30. The heating device 13 arranged therein heats the air before it enters the storage container 15. In accordance with the preceding embodiments, the heated air flows through the funnel-shaped outlet end 14 in downward direction into the bulk material 16 through which the air then flows upwardly. It absorbs thus the moisture from the bulk material 16 and passes through outlet 18 and the air filter 19 again into the connecting conduit 21. In this way, the drying air is guided in circulation wherein the moisture contained in the drying air is removed in the heat exchanger 3a. By preheating while passing through the heat exchanger 2a and heating by the heating device 13, the drying temperature is heated so much that it can optimally absorb the moisture from the bulk material 16 without the bulk material becoming damaged by a heating action that is too strong.

In the embodiment according to FIG. 8, the dehumidifying unit 10, as a pre-stage, is arranged upstream of a conventional drying device for bulk material. The dehumidifying unit that is upstream of the dryer ensures that the ambient air before entering the dryer 33 has been sufficiently dehumidified. This device is suitable advantageously when used in regions in which the ambient air has a high moisture contents. Such climatic conditions exists, for example, in Asian regions. By arranging the dehumidifying unit 10 upstream, the conventional dryers can be employed with which in this way a significant performance improvement of the energy efficiency is achieved for drying bulk material.

By means of the blower 12, ambient air is sucked through the air filter 11 into the dryer 33. The air flows subsequently through the heat exchanger 3a from the top to the bottom and is thereby dehumidified in the described way. The condensate that is formed can be discharged through the outlet pipe 4. The ambient air flows subsequently into the heat exchanger 2a through which it flows from the bottom to the top and by means of which it is preheated. The dehumidified pre-heated ambient air passes into a conduit 34 with which the ambient air is supplied to the dryer 33. In the conduit 34 a valve 35 is positioned with which the supply of pre-heated dehumidified air can be blocked.

The conduit 34 opens into the connecting conduit 21 that connects the outlet 18 of the storage container 15 for the bulk material 16 with the dryer 33. The air filter 19 is arranged within the dryer in the connecting conduit 21 upstream of the blower 12. The conduit 34 opens in the area between the blower 12 and the air filter 19 into the connecting conduit 21.

Within the dryer 33 a diverter valve 36 is arranged downstream of the blower 12 with which alternatingly two drying cartridges 37, 38 can be connected to the system. In the illustrated embodiment the diverter valve 36 is switched such that the pre-heated dehumidified air flows through the drying cartridge 38. In flow direction behind the drying cartridge 38 there is a heating device 39 with which the air before entering the storage container 15 is heated to the required drying temperature. The preheated air flows into the supply conduit 30 in which the heating device 13 is located. The accordingly heated drying air flows in the storage container 15 from the bottom to the top through the bulk material 16 and absorbs its moisture. At the outlet 18 the return air flows through the connecting conduit 21 and the air filter 19 back into the dryer 33. The valve 35 in the conduit 34 is closed so that then no new ambient air is supplied as long as the return air is circulated through the dryer. The return air, when passing through the drying cartridge 38 again, is dried conventionally so that it is passed into the storage container 15 after having been heated again by means of the heating devices 39 and 13.

The diverter valve 36 can be switched such that the return air is passed through the drying cartridge 37 and from there is released into the environment. When the diverter valve 36 is switched again, the valve 35 is opened so that by means of the blower 12 ambient air is sucked in that first flows through the dehumidifying unit 10 and then in the described way is supplied to the storage container 15.

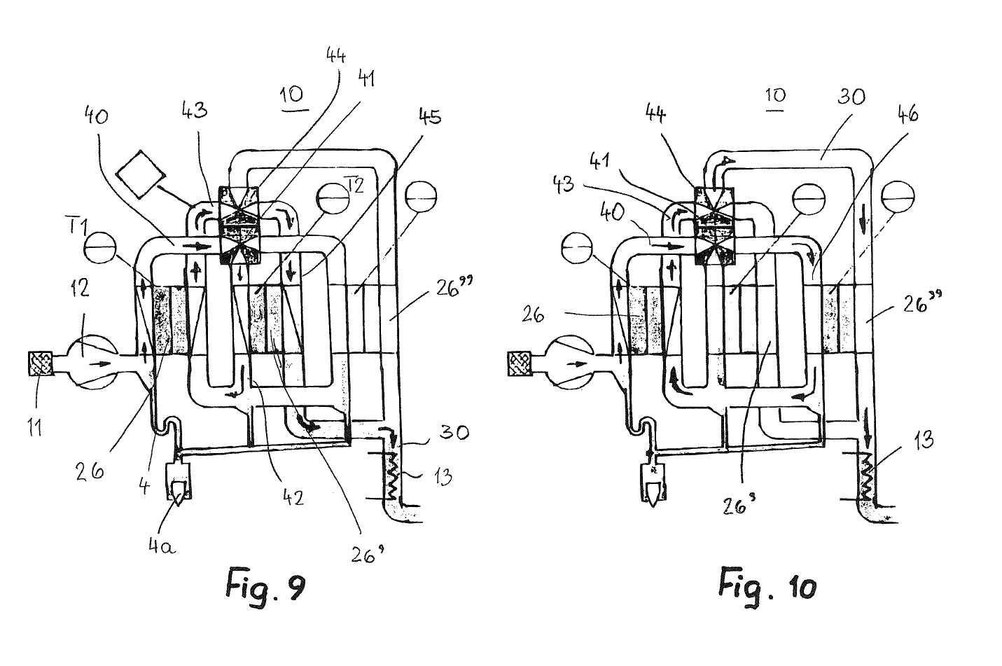

The embodiment according to FIGS. 9 and 10 is excellently suitable for systems with dew points below 0 degrees Celsius. With the dehumidifying unit 10 a two-stage dehumidification for drying the bulk material 16 in the storage container 15 is performed. The dehumidifying unit has the Peltier device 26 with which the process air is pre-dehumidified. In order to prevent ice from forming, the cold side of the Peltier device 26 is maintained constantly at a temperature T1 which in the embodiment is +5 degrees Celsius. The ambient air that is sucked in by the blower 12 through the air filter 11 flows across this cold side of the Peltier device 26. The resulting condensate can drip downwardly into the outlet pipe 4 and in this embodiment can be removed by the float valve 4a. The ambient air flows across the cold side of the Peltier device 26 upwardly and enters a conduit 40 in which a valve 41 is located. It is switched such that the pre-dehumidified ambient air can flow downwardly into a conduit 42. In the conduit 42 the ambient air flows across the cold side of the Peltier device 26′ in downward direction and passes into a return conduit 43. In it, the air that has been converted by dehumidification to drying air flows upwardly across the hot side of the Peltier device 26 so that the drying air is now preheated. In the return conduit 43, a valve 44 is disposed by means of which the drying air can pass into a further conduit 45. In this way, the drying air is passed across the hot side of the Peltier device 26′ and reaches then the supply conduit 30, by means of which the drying air can pass into the storage container 15 (not illustrated). With the heating device 13 in the supply conduit 30 the dehumidified and pre-heated drying air is then heated to the required temperature for drying the bulk material 16 in the storage container 15.

The Peltier device 26′ is maintained at a temperature as low as possible, preferably, below 0 degrees Celsius, in order to reach a correspondingly low dew point. Accordingly, on the Peltier device 26′ ice is formed.

Parallel to this, the cold side of the Peltier device 26″ is briefly heated by a brief polarity reversal of the load voltage and thus deiced. While the dehumidified drying air is thus passed across the hot side of the Peltier devices 26, 26′ and heated, in this phase the Peltier device 26″ is deiced in the described way. During this regeneration process, this Peltier device 26″ is decoupled from the flow path of the air in the dehumidifying unit 10.

Once the Peltier device 26″ is deiced, the two valves 41, 44 are switched (FIG. 10). Now the dehumidified ambient air flows in the conduit 40 through the valve 41 into a conduit 46 in which the air is passed across the cold side of the Peltier device 26″. By switching the valve 41 the Peltier device 26′ has been removed from the flow path of the air. This Peltier device 26′ is switched by brief polarity reversal so that the cold side now becomes the hot side. In this way, the ice that has been formed as a result of moisture removal from the air on the cold side of this Peltier device 26′ is removed. When this deicing process is completed, the valves 41, 44 are switched again so that now the Peltier device 26″ can be deiced. In this way, the Peltier devices 26′ and 26″ each are deiced alternatingly.

During the deicing process of the Peltier device 26′ the valve 44 is switched such that the dehumidified drying air that is supplied through the return conduit 43 after having passed across the hot side of the Peltier device 26 reaches the supply conduit 30 in which the drying air is heated by means of the hot side of Peltier device 26″ and the heating device 13 to the required temperature for drying the bulk material in the storage container.

This two-stage Peltier dehumidification can be carried out as an open process, as explained in connection with FIGS. 9 and 10, but also as a closed process.

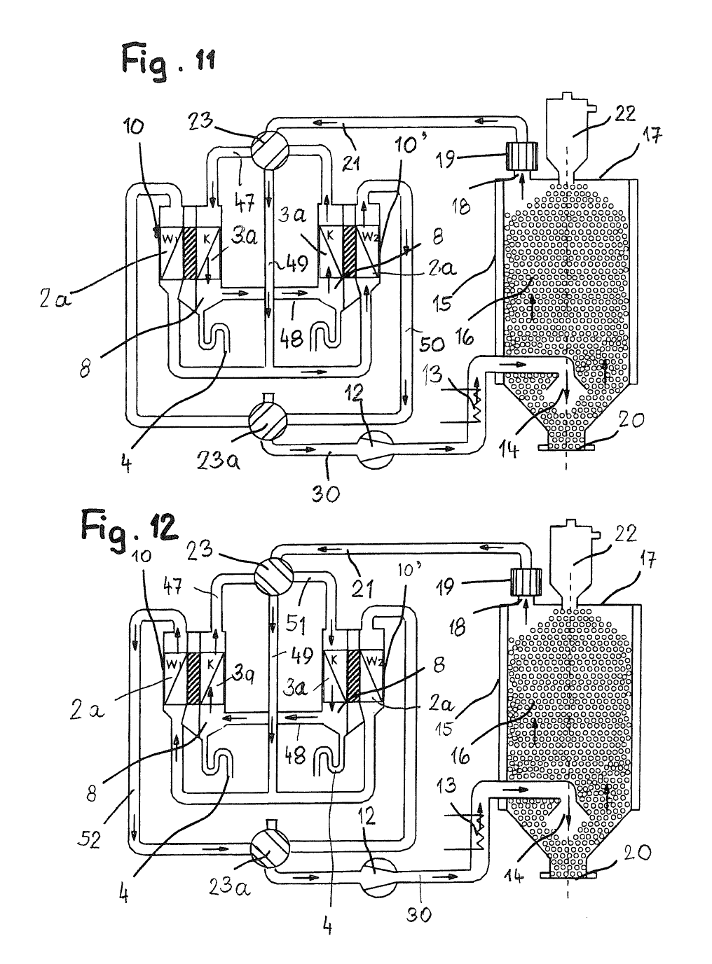

In the embodiment according to FIGS. 11 and 12, a closed system with dew points below the freezing point is disclosed. The device has the two dehumidifying units 10, 10′ with Peltier devices.

The bulk material 16 contained in the storage container 15 is flowed through by the heated dehumidified air in upward direction. Via the outlet 18 in the cover 17 of the storage container 15 and the air filter 19 the air passes into the connecting conduit 21.

On the cover 17 of the storage container 15 there is a filling device 22 through which the storage container 15 is filled with the bulk material 16. The filling device 22 is embodied in a way known in the art.

The valve 23 is switched such that the connecting conduit 21 is fluidically connected with a supply conduit 47. Through it the return air is supplied from the storage container 15 to the heat exchanger 3a of the dehumidifying unit 10. In this dehumidifying unit the Peltier device is not in operation. However, since this concerns a process alternating between FIGS. 11 and 12, ice has formed in this chamber after the preceding process course of FIG. 12. The return air flows through the heat exchanger 3a from top to bottom wherein the moisture condenses on the ice and, at the same time, the formed ice will thaw because of the hot return air and also by the condensation heat. The condensate that is formed in the heat exchanger 3a can be drained through the outlet pipe 4 with the siphon.

After exiting from the heat exchanger 3a, the pre-dehumidified return air flows through the flow chamber 8 into a connecting conduit 48 that opens into the flow chamber 8 of the other dehumidifying unit 10′. The dehumidified return air flows through the heat exchanger 3a of this additional dehumidifying unit 10 upwardly and is guided through valve 23 into a conduit 49 in which the return air is supplied to the heat exchanger 3a of the dehumidifying unit 10′. In this second cold heat exchanger 3a the moisture of the return air is removed by the Peltier device by ice formation on the heat exchanger and thus very low dew points are reached. The dehumidified return air is thus converted to drying air, passes through the heat exchanger 2a from bottom to top, is heated and then reaches the return conduit 50 in which the dehumidified, pre-heated drying air is supplied through valve 23 to the supply conduit 30. In it the blower 12 is located. By means of the heating device 13 in the supply conduit 30, the drying air, before entering the storage container 15, is heated to the temperature required for drying the bulk material 16. Within the storage container 15 it exits from the outlet end 14 of the supply conduit 30 in downward direction and passes through the bulk material 16 from bottom to top.

In the described way the drying air is guided in circulation.

With the filling device 22 the bulk material 16 is introduced in batches into the storage container 16. By means of the container outlet 20 the bulk material is also removed in batches after the drying process.

The filling device 22 can also be used in the afore described embodiments as well as in the embodiments explained in the following.

By serially connecting the two dehumidifying units 10, 10′, an increased dehumidification performance and thus a significant improvement of the dehumidifying process is achieved. Primarily, by means of thawing the ice with the return air and condensation heat, the regeneration of the icy chambers is carried out in an especially energy-saving way.

Through the valve 23 the return air is supplied through the supply conduit 47 to the heat exchanger 3a. The ice that forms on the cold side of the heat exchanger 3a is deiced during the afore described process step. The moist return air from the storage container 15 contains still significant residual heat from the drying process from drying the bulk material 16. The hot return air as well as the condensation of the moisture and the thus released condensation heat results in that the ice is melted and the condensate is removed through the outlet pipe 4 from the system. By this condensation the moist return air is dried and cooled. This process is performed until the ice formed in the heat exchanger 3a has been completely removed and enough ice has collected in the heat exchanger 3a of the dehumidifying unit 10′ that must now be removed.

For this purpose, by means of the valve 23, the flow direction of the return air coming from the storage container 15 is changed (FIG. 12). The return air now flows from the connecting conduit 21 into the supply conduit 51 through which the return air is supplied to the heat exchanger 3a of dehumidifying unit 10′. The return air flows through the heat exchanger 3a from top to bottom. In doing so, the moist return air is dehumidified and the ice of the preceding process is thawed. The resulting condensate can flow in downward direction into the outlet pipe 4. After passing through the heat exchanger 3a the dehumidified return airflows through the flow chamber 8 into the connecting conduit 48. In contrast to the switching position of the valve 23 of FIG. 11, the dehumidified return air passes the connecting conduit 48 in reverse direction and reaches through the flow chamber of the dehumidifying unit 10 its heat exchanger 3a whose Peltier device is now in operation. When passing this heat exchanger 3a from bottom to top, the return air is dehumidified further and ice is formed. Through the supply conduit 47 and the valve 23 the return air that has been converted by dehumidification to drying air flows into the conduit 49 and from there through the heat exchanger 2a of the dehumidifying unit 10. In the heat exchanger 2a the drying air is preheated. It flows through the heat exchanger 2a from bottom to top and reaches a connecting conduit 52 in which the preheated drying air flows into the supply conduit 30 through the switched valve 23a. Before entering the storage container 15, the preheated drying air is heated by means of the heating device 13 to the temperature required for drying the bulk material 16. It exits from the outlet end 14 within the storage container 15 and flows through the bulk material 16 in upward direction. While doing so, it absorbs moisture from the bulk material 16. The moist return air is then guided through the outlet 18 and air filter 19 back into the connecting conduit 21 in order to subject the return air to a new drying circulation.

Both valves 23, 23a are always switched between the switching positions according to FIG. 11 and according to FIG. 12. After the return gas has passed the heat exchangers 3a of the dehumidifying units 10, 10′ the dehumidified return air that is now drying air is passed through the hot side in the form of the heat exchangers 2a in order to absorb here the exhaust heat and heat loss of the cooling process.

In the valve position according to FIG. 11 the drying air is not guided through the heat exchanger 2a of the dehumidifying unit 10 because the deicing process is carried out only passively hereat and for this reason this conduit part is blocked at the valve 23a. The return air that is supplied across the hot site (heat exchanger 2a) of the dehumidifying unit 10′ is passed through the correspondingly switched valve 23a into the supply conduit 30.

When the described deicing process is to be performed in the two dehumidifying units 10, 10′ or their heat exchangers 3a, the valves 23, 23a are switched simultaneously.

In the illustrated embodiment, the blower is arranged downstream of the valve 23a in the flow direction. The blower 12 could well be positioned also in flow direction upstream of the valve 23 in the connecting conduit 21. The blower 12 forces the dried air through the heating device 13 in the described way again into the storage container 15 in order to dehumidify the bulk material 16. The described process is continuously repeated. The frequency of switching of the valves 23, 23a depends on the existing moisture quantity of the bulk material 16.

The described device is a closed system with dew points below the freezing point.

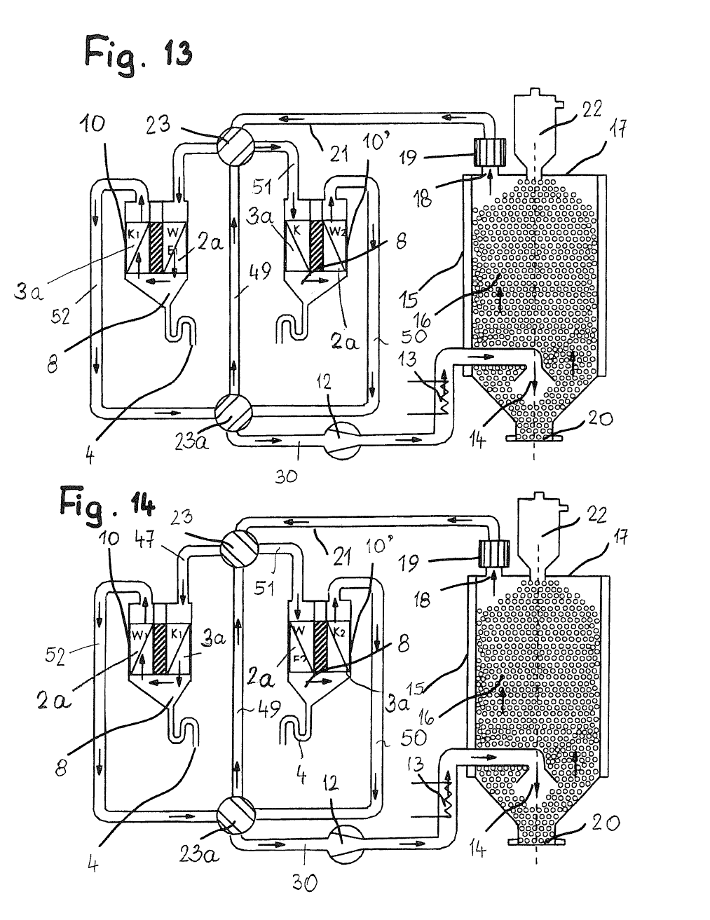

While in the embodiment according to FIGS. 11 and 12 thawing is passively done by passing the moist return air through the heat exchanger 3a, the thawing process in the embodiment according to FIGS. 13 and 14 is performed actively in that the Peltier devices of the dehumidifying units are reversed in polarity such that the cold side of the Peltier devices become the hot side. When doing so, the prior hot side becomes the cold side of the Peltier devices. The device according to FIGS. 13 and 14 is basically of the same configuration as the preceding embodiment. The return air that exits through outlet 18 and the air filter 19 from the storage container 15 flows through the connecting conduit 21 and the valve 23 to the heat exchanger 2a of the dehumidifying unit 10. In contrast to the preceding embodiment, the Peltier devices of the dehumidifying units 10 are reversed in polarity so that the prior cold side now is the hot side of the Peltier devices. Accordingly, the ice of the prior cold side is now melted by the hot return air, by the condensation and the release of the condensation heat. The return air flows from top to bottom through the heat exchanger 2a and reaches through the flow chamber 8 the heat exchanger 3a. Here the return air flows in upward direction and reaches through connecting conduit 52 and the valve 23a the conduit 49. The condensate that is generated in the heat exchanger 3a can flow through the connecting chamber 8 into the outlet pipe 4 through which the condensate is removed from the process.

The return air upon passing through the heat exchanger 3a is cooled. In this way, the air temperature is further decreased. This means that condensate is also precipitated and can reach through the connecting chamber 8 the outlet pipe 4. The cooling temperature is limited so that in the heat exchanger 3a no ice formation occurs.

The return air flows in the conduit 49 through the valve 23 and the supply conduit 51 into the heat exchanger 3a of the dehumidifying unit 10′. When passing through the heat exchanger 3a the moisture of the return air is removed and is precipitated as ice on the cold side of the Peltier devices. The return air flows through the heat exchanger 3a from the top to the bottom, is converted by dehumidification to drying air and reaches through the flow chamber the heat exchanger 2a which is flowed through by the drying air from bottom to top. The drying air that is preheated in this way flows through the return conduit 50 and the valve 23a into the supply conduit 30. By means of the heating device 13 the drying air, before entering the storage container 15, is heated to the required temperature. The heated drying air exits from the outlet end 14 provided in the storage container 15 and flows through the bulk material 16 in upward direction. It entrains the moisture from the bulk material 16 and flows at the outlet 18 as moist return air back into the connecting conduit 21.

In the position according to FIG. 14 the two valves 23, 23a are switched. This has the result that the moist return air exiting from the outlet 18 flows through the connecting conduit 21 and the valve 23 into the supply conduit 51. The moist return air flows through the supply conduit 51 into the heat exchanger 2a of the dehumidifying unit 10′. The Peltier devices of both dehumidifying units 10′ and 10 are reversed in polarity so that the prior cold sides are now the hot sides. Accordingly, by means of the moist hot return air the ice that has formed on the prior cold sides is melted. The resulting condensate can flow down into the outlet pipe 4. Through the flow chamber 8 partially dehumidified return air flows from the bottom to the top through the heat exchanger 3a of the dehumidifying unit 10′ wherein the return air is further cooled and further condensate is precipitated. Through the return conduit 50 and the valve 23a, the return air flows into the conduit 49 in which it flows into the heat exchanger 3a of the dehumidifying unit 10 via the valve 23 and supply conduit 47. The heat exchanger 3a is flowed through from top to bottom wherein the residual moisture is separated from the return air by ice formation on the cold heat exchanger 3a. The dehumidified return air is now converted to drying air by dehumidification and flows then upwardly for preheating through the heat exchanger 2a of the dehumidifying unit 10 and flows via the connecting conduit 52 and the valve 23a into the supply conduit 30 in which the blower 12 is disposed. By means of the heating device 13 the drying air, before entering the storage container 15, is heated to the temperature required for drying the bulk material. The heated drying air passes through the outlet end 14 into the storage container and flows through the bulk material 16 in upward direction. Through the outlet 18 the moist return air is returned into the connecting conduit 21.

The valves 23, 23a are switched alternatingly in order to perform icing and deicing alternatingly.

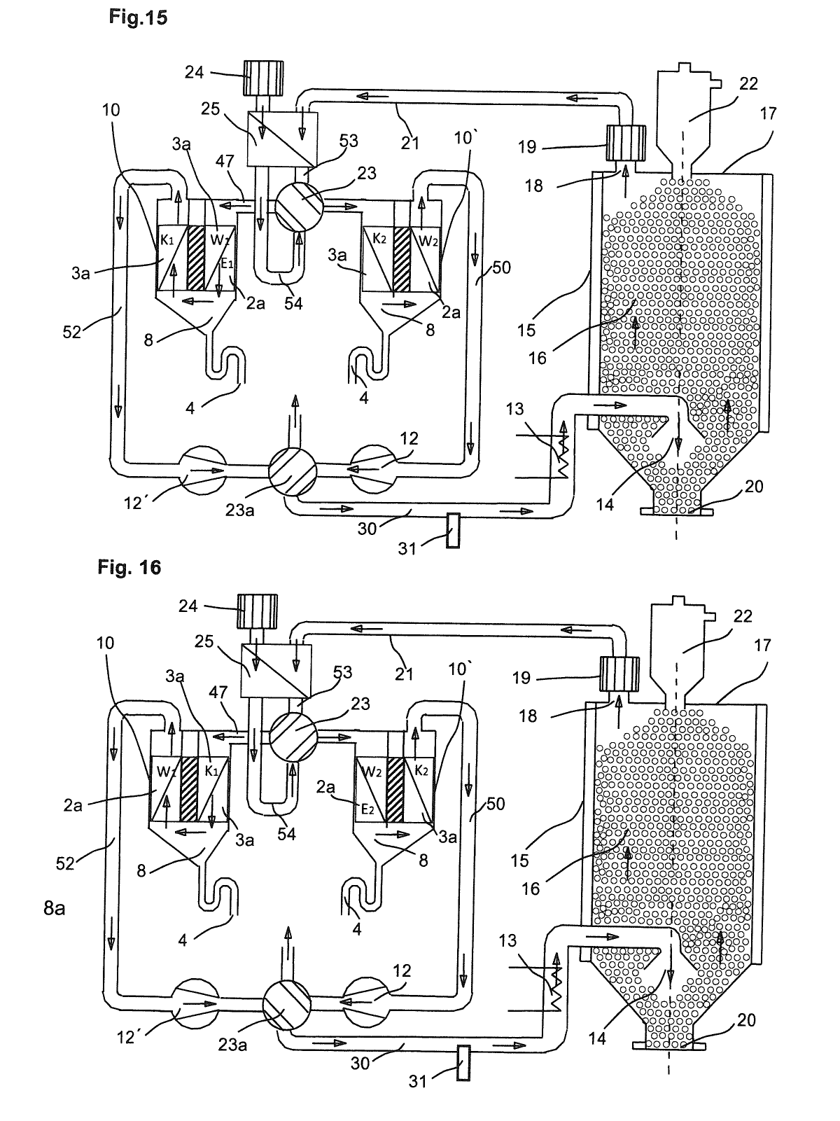

The device according to FIGS. 15 and 16 enables a drying process with dew points of the drying air below the freezing point wherein the formed ice at the cold side of the Peltier devices is actively thawed in that the Peltier devices are reversed in polarity and, at the same time, exhaust heat of the return air is utilized by means of a heat exchanger 25. Also, regeneration and drying are performed in separate circuits.

In this embodiment a separate air circulation is constructed in order to thaw the ice that is formed in the dehumidifying units 10, 10′. The moist return air that passes from the storage container 15, after having passed the bulk material 16, through the outlet 18 and the air filter 19 into the connecting conduit 21 is supplied to a heat exchanger 25. Through an air filter 24 ambient air is also supplied to the heat exchanger 25. The moist return air is cooled upon passing through the heat exchanger 25. At the same time, the ambient air sucked in through the air filter 24 is preheated in the heat exchanger 25 in order to remove subsequently the ice formed on the cold side of the Peltier devices.

After having passed through the heat exchanger 25 the air passes into a conduit 53 in which the valve 23 is seated. It is switched such that the return air passes into the heat exchanger 3a of the dehumidifying unit 10′. The return air flows through the heat exchanger 3a from top to bottom and is cooled while doing so and is dried by condensation or ice formation of the moisture. The condensate that forms can flow downwardly into the outlet pipe 4 and ice that is being formed is deposited in the heat exchanger. Through the flow chamber 8 the return air that has been largely dehumidified flows into the heat exchanger 2a of the dehumidifying unit 10′ and has now been converted by dehumidification into drying air. The drying air flows through the heat exchanger 2a from the bottom to the top, enters the return conduit 50 and passes through the blower 12 that is fluidically connected through valve 23a with the supply conduit 30. Before entering the storage container 15 the dehumidified and preheated drying air is now heated by means of heating device 13 to the temperature required for drying the bulk material. Through the outlet end 14 the heated drying air enters the storage container 15 and flows through the bulk material 16 in upward direction. Through the outlet 18 and the air filter 19 the drying air that is loaded with moisture enters as return air the connecting conduit 21. In the described way the return air in the circuit is passed through the device whereby it is dehumidified, preheated and heated to the temperature required for drying the bulk material 16.

The ambient air that is sucked through the air filter 24 into the heat exchanger 25 flows after having passed the heat exchanger into a conduit 54 which is fluidically connected through valve 23 with the supply conduit 47 extending to the dehumidifying device 10. The ambient air that is heated in the heat exchanger 25 flows from the bottom to the top of the heat exchanger 2a of the dehumidifying unit 10. The Peltier device of the dehumidifying unit 10 is reversed in polarity so that the prior cold side becomes the hot side. The ice that has formed on the prior cold side is now thawed by the new hot side of the Peltier device and the preheated ambient air that is passing through the heat exchanger 2a. After having passed the heat exchanger 2a, the ambient air now flows through the flow chamber 8 into the heat exchanger 3a through which it flows in upward direction. The cooled ambient air is now supplied through connecting conduit 52 and through valve 23a into the environment. In the connecting conduit 52 the blower 12′ is located with which the ambient air is sucked in. The blower 12 that is positioned in the supply conduit 50 drives the dehumidified and preheated dry air. The blowers for the drying circuit could also be provided in the conduit 21 and for regeneration or deicing in the conduit 54 or at other locations that enable the dual circuit operation.

Deicing in the dehumidifying unit 10 is performed with separate air flow relative to the drying process in the described way. The regeneration of the respective dehumidifying unit 10, 10′ is done parallel to drying of the bulk material 16.

Over time, on the cold side of the Peltier device of the dehumidifying unit 10′ ice is formed. With increasing thickness of the ice formed thereon the dehumidifying performance of the dehumidifying unit decreases. One possibility of performing the regeneration is to switch the process after certain time intervals and to perform deicing. It is also possible to measure in the supply conduit 30 the dew point with a sensor 31 and to then switch the process circuit from FIG. 15 to FIG. 16 or vice versa when the minimal nominal dew point can no longer be maintained. In order to remove the ice, the valves 23, 23a are switched so that the return air as well as the sucked-in ambient air have a different flow path (FIG. 16). The moist return air that exits at the outlet 18 from the storage container 15 after having flowed through the bulk material 16 passes through air filter 19 into the connecting conduit 21 with which the moist return air is supplied to the heat exchanger 25. As a result of switching of the valve 23 the moist return air that has been cooled by the heat exchanger 25 flows via the supply conduit 47 through the heat exchanger 3a of the dehumidifying unit 10. The return air flows through the heat exchanger 3a from top to bottom and is cooled by doing so and the moisture is largely separated from the return air by condensation and ice formation, as described above. Through the flow chamber 8 the return air reaches the heat exchanger 2a of the dehumidifying unit 10. The heat exchanger 2a is flowed through from bottom to top whereby the return air is heated. The dried return air is thus converted into heated drying air. Through the connecting conduit 52, the blower 12′ and the switched valve 23a, the drying air passes into the supply conduit 30. By means of the heating device 13 the drying air is heated to the temperature required for drying the bulk material 16. The drying air exits through outlet end 14 into the storage container 15 and flows through the bulk material 16 in upward direction. The return air that is moist after having passed through the bulk material 16 is supplied again to the heat exchanger 25 through outlet 18 and the air filter 19 and through the connecting conduit 21.

The ambient air that has been sucked in through air filter 24 flows also through the heat exchanger 25 and is heated by doing so. Via the conduit 54 and the switched valve 23 the heated ambient air flows into the heat exchanger 2a of the dehumidifying unit 10′. In this connection, by the heated ambient air and by reversing polarity of the Peltier device of the dehumidifying unit 10′, the ice formed in the prior process circuit FIG. 15 is thawed. The condensate that is formed flows into the outlet pipe 4, through which the condensate can be removed from the system. The ambient air flows through the flow chamber 8 to the heat exchanger 3a of the dehumidifying unit 10′. The Peltier devices of the dehumidifying unit 10′ are reversed in polarity in order to accelerate deicing. The ambient air is exhausted through return conduit 50, the blower 12 and the switched valve 23a into the environment.

By switching the valves 23, 23a, the two dehumidifying units 10, 10′ are deiced alternatingly with the ambient air while parallel and simultaneously drying of the bulk material 16 is performed.

In the embodiments of FIGS. 13 to 16, the filling device 22, with which a batch-wise filling of the storage container 15 with bulk material is possible, is also provided on the cover 17 of the storage container 15 in accordance with the embodiment of FIGS. 11 and 12. The filling device 22 is an advantageous embodiment of all storage containers and is also possible in FIGS. 4, 5, 6 and 7. Filling can also be done without such a filling device 22 in other ways.

In the embodiments of FIGS. 11 to 14, switching of the process circuit for regeneration or for deicing can also be performed, in accordance with the embodiment of FIGS. 15 and 16, based on time intervals or in that the dew point of the drying air in the supply conduit 30 is measured by means of dew point sensor 31 so that switching is performed upon dropping below a certain dehumidifying performance.

The specification incorporates by reference the entire disclosure of German priority document 10 2010 021 742.5 having a filing date of May 20, 2010.

While specific embodiments of the invention have been shown and described in detail to illustrate the inventive principles, it will be understood that the invention may be embodied otherwise without departing from such principles.

What is claimed is:

1. A device for drying bulk material, the device comprising:
at least one storage container containing bulk material;
at least one supply conduit for a gaseous drying medium opening into said at least one storage container;
at least one outlet conduit connected to said at least one storage container, wherein the drying medium in the form of return air, loaded with moisture after having passed the bulk material, flows through said at least one outlet conduit out of said at least one storage container;
a dehumidifying unit that dehumidifies the drying medium;
wherein said dehumidifying unit comprises a Peltier device having a cold side and a hot side;
wherein said cold side and said hot side are positioned within a flow path of the drying medium through the device.

2. The device according to claim 1, wherein said cold side and said hot side each form a part of a heat exchanger, respectively.

3. The device according to claim 1, wherein said at least one supply conduit is fluidically connected with said dehumidifying unit.

4. The device according to claim 1, wherein said dehumidifying unit is fluidically connected with said at least one outlet conduit of said at least one storage container.

5. The device according to claim 1, comprising at least one intake conduit for ambient air that is connected to said dehumidifying unit.

6. The device according to claim 1, wherein said dehumidifying unit is provided as a pre-stage.

7. The device according to claim 1, wherein said dehumidifying unit is positioned in a circuit of the drying medium.

8. The device according to claim 1, comprising a first one and a second one of said dehumidifying unit, wherein said first dehumidifying unit is subjected to a deicing process and said second dehumidifying unit is used parallel to said deicing process for dehumidifying the drying medium.

9. The device according to claim 8, comprising valves that control the flow path of the drying medium through the device.

10. The device according to claim 1, wherein said dehumidifying unit has several of said Peltier device arranged in series neighboring each other.

11. The device according to claim 1, wherein said dehumidifying unit has several of said Peltier device arranged in series one after another.

12. The device according to claim 1, wherein said dehumidifying unit has several of said Peltier device arranged in series one after another and neighboring each other.
